(19) United States
(12) Patent Application Publication
(10) Pub. No.: US 2024/0187496 A1
(43) Pub. Date: Jun. 6, 2024

(54) CONTROL SYSTEM OPERATION METHOD, CONTROL SYSTEM, AND PROGRAM

(71) Applicant: Yamaha Corporation, Hamamatsu (JP)

(72) Inventors: Takahiro IWATA, Tokyo (JP); Yuki SETO, Tokyo (JP)

(21) Appl. No.: 18/444,091

(22) Filed: Feb. 16, 2024

Related U.S. Application Data
(63) Continuation of application No. PCT/JP22/29918, filed on Aug. 4, 2022.

(30) Foreign Application Priority Data
Aug. 18, 2021 (JP) 2021-133125

(51) Int. Cl. H04L 67/52

(52) U.S. Cl. CPC H04L 67/52

(57) ABSTRACT

A control system operation method includes determining whether a terminal device is located at a venue where an event is taking place, and delivering first content pertaining to the event to the terminal device in parallel with progression of the event in response to determining that the terminal device is located at the venue.

### CROSS-REFERENCE TO RELATED APPLICATIONS

This application is a continuation application of International Application No. PCT/JP2022/029918, filed on Aug. 4, 2022, which claims priority to Japanese Patent Application No. 2021-133125 filed in Japan on Aug. 18, 2021. The entire disclosures of International Application No. PCT/JP2022/029918 and Japanese Patent Application No. 2021-133125 are hereby incorporated herein by reference.

### BACKGROUND

### Technical Field

This disclosure relates to technology for distributing content to terminal devices.

### Background Information

Technologies have been conventionally proposed for delivering content pertaining to various events, such as sporting events or musical events, to terminal devices in parallel with the progression of the event. For example, Japanese Laid-Open Patent Application No. 2003-87760 discloses a technology for delivering digital data including video and audio data to a terminal device.

### SUMMARY

The widespread use of technology for the distribution of event content to terminal devices that are located remotely from the venue in which the event is being held may possibly result in a reduced number of users actually visiting the event venue. In consideration of such an eventuality, one aspect of this disclosure relates to promoting the attendance of users at event venues.

In order to solve the problem described above, a control system operation method according to one aspect of this disclosure comprises determining whether a terminal device is located at a venue in which an event is taking place, and delivering to the terminal device first content pertaining to the event in parallel with progression of the event in response to determining that the terminal device is located at the venue.

A control system according to another aspect of this disclosure comprises an electronic controller including at least one processor configured to determine whether a terminal device is located at a venue in which an event is taking place, and deliver to the terminal device first content pertaining to the event in parallel with progression of the event in response to determination that the terminal device is located at the venue.

A non-transitory computer-readable medium storing a program according to another aspect of this disclosure causes a computer system to perform functions comprising determining whether a terminal device is located at a venue in which an event is taking place, and delivering to the terminal device first content pertaining to the event in parallel with progression of the event in response to determining that the terminal device is located at the venue.

### BRIEF DESCRIPTION OF THE DRAWINGS

FIG. 1 is a block diagram illustrating the configuration of an information system in a first embodiment.

FIG. 2 is a block diagram illustrating the configuration of a recording system.

FIG. 3 is a block diagram illustrating the configuration of a control system.

FIG. 4 is a block diagram illustrating the functional structure of the control system.

FIG. 5 is a flowchart illustrating the steps of a control process.

FIG. 6 is a flowchart illustrating the steps of a generation process.

FIG. 7 is a flowchart illustrating the steps of the generation process in a second embodiment.

FIG. 8 is a flowchart illustrating the steps of the generation process in a third embodiment.

FIG. 9 is a block diagram illustrating the functional configuration of the control system in a fourth embodiment.

### DETAILED DESCRIPTION OF THE EMBODIMENTS

Selected embodiments will now be explained in detail below, with reference to the drawings as appropriate. It will be apparent to those skilled in the field from this disclosure that the following descriptions of the embodiments are provided for illustration only and not for the purpose of limiting the invention as defined by the appended claims and their equivalents.

### A: First Embodiment

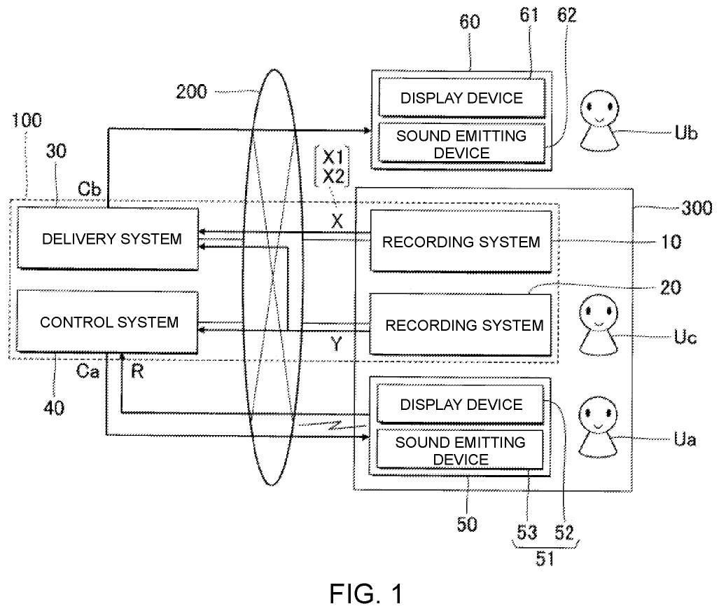

FIG. 1 is a block diagram illustrating the configuration of an information system 100 in a first embodiment. The information system 100 is a computer system that provides content C (Ca, Cb) to one or more terminal devices 50 and one or more playback devices 60. The information system 100 communicates with each of the terminal devices 50 and playback devices 60 via a communication network 200, such as the Internet, for example. Although the actual information system 100 communicates with a plurality of terminal devices 50 and a plurality of playback devices 60, for the sake of convenience, the following explanation will focus on one terminal device 50 and one playback device 60.

In FIG. 1, a user Ua uses the terminal device 50. The terminal device 50 is a portable information device, such as a mobile phone, a smartphone, a tablet terminal, or a personal computer. The terminal device 50 communicates with the communication network 200 wirelessly, for example. The user Ua can visit the venue 300 while carrying the terminal device 50. The venue 300 is a facility where various events are held. The venue 300 of the first embodiment is a stadium or a gymnasium where an event is held in which multiple contestants compete in a particular sport (referred to as a “competitive event” below) and where the user Ua who visits the venue 300 watches the competitive event in the venue 300.

The terminal device 50 incudes a playback device 51. The playback device 51 is a video device that plays back content Ca. The content Ca includes audio that explains the state of the competitive event held in the venue 300 (referred to as “audio commentary” below). The playback device 51 of the first embodiment includes a display device (display) 52 for displaying images and a sound emitting device 53 (for example, speaker) for playing back sound. The audio commentary represented by the content Ca is emitted by the sound emitting device 53. Note that content Ca is an example of “first content.”

A user Ub in FIG. 1 uses the playback device 60 outside the venue 300. For example, the user Ub is in a remote location from the venue 300 (for example, at home or in a foreign country). The playback device 60 plays back content Cb. The content Cb is video and audio that represent the state of the competitive event taking place in the venue 300. More specifically, the playback device 60 includes a display device (display) 61 that displays the video images of the content Cb and a sound emitting device 62 (for example, speaker) that plays the sound of content Cb. For example, a television receiver can be used as the playback device 60. Further, an information device such as a smartphone or tablet terminal can be used as the playback device 60. A large video device that can be viewed by a large number of the users Ub (public viewing) can be used as the playback device 60. The content Cb can be information that includes only audio (for example, a radio program). The content Cb is an example of “second content.”

As can be understood from the foregoing description, the user Ua is a viewer directly watching the competitive event in the venue 300, and the user Ub is a viewer watching the competitive event outside the venue 300 using the content Cb played back on the playback device 60.

The information system 100 includes a recording system 10, a recording system 20, a delivery system 30, and a control system 40. The recording system 10 and the recording system 20 are installed in the venue 300. Note that any two or more elements of the information system 100 can be integrally configured. For example, the recording system 20 can be configured as part of the recording system 10. For example, the delivery system 30 and the control system 40 can be configured as a single device. Further, any one or more elements in the information system 100 can be excluded from the elements of the information system 100. For example, the information system 100 can comprise the recording system 20 and the control system 40.

The recording system 10 generates recorded data X by recording a competitive event. The recorded data X include video data X1 and audio data X2. The video data X1 represent images taken in the venue 300. For example, the video data X1 represent the video of the competitive event. The audio data X2 represent sound collected in the venue 300. For example, the audio data X2 represent various types of sounds, such as the sounds uttered by contestants or judges in a competitive event, the sounds of actions produced during competition, the cheers from the spectators in the venue 300, etc. More specifically, the recording system 10 includes an imaging device (for example, video camera) that generates the video data X1 and a sound recording device (sound recorder) that generates the audio data X2 (not shown). The recording by the recording system 10 is performed in parallel with the progression of the competitive event. The recorded data X are transmitted to the delivery system 30.

The recording system 20 is a sound system (sound facility) installed in a broadcast room in the venue 300. The recording system 20 of the first embodiment generates sound data Y. The sound data Y are recorded data recorded in parallel with the progression of the competitive event. The sound data Y of the first embodiment represent the audio commentary uttered by a commentator Uc. The commentator Uc is located in the broadcast room in the venue 300 where the competitive event can be viewed and provides verbal commentary on the state of the competitive event in parallel with the progression of the competitive event. In other words, the sound data Y of the first embodiment represent sound, in particular, speech pertaining to the competitive event. The sound data Y are transmitted to the delivery system 30 and the control system 40. The sound represented by the sound data Y is not limited to the audio commentary used as an example above. For example, the recording system 20 can generate sound data Y that represent audio guidance for guiding visitors in the venue 300 or sound data Y that represent broadcast audio for informing visitors in the venue 300 of the occurrence of an emergency such as an earthquake.

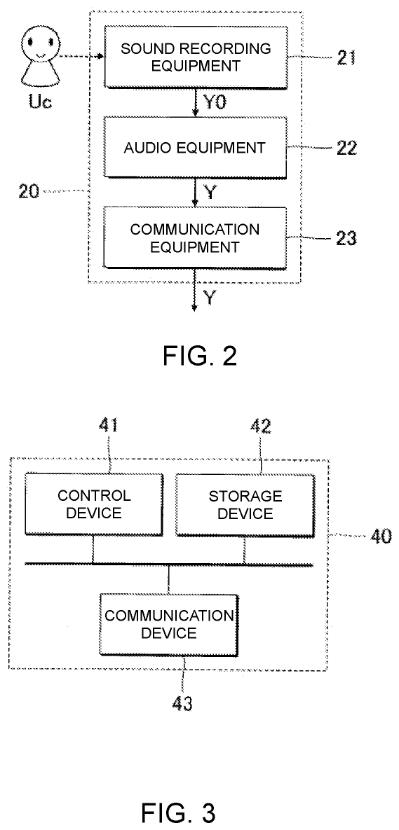

FIG. 2 shows a block diagram of the configuration of the recording system 20. As shown in FIG. 2, the recording system 20 includes a sound recording equipment 21, an audio equipment 22, and a communication equipment 23. The sound recording equipment 21 is a microphone that generates an audio signal Y0 by detecting ambient sound. The audio equipment 22 is a mixer that generates the sound data Y by adjusting the audio characteristics of the audio signal Y0. The communication equipment 23 transmits the sound data Y to the delivery system 30 and the control system 40.

The delivery system 30 of FIG. 1 delivers the content Cb corresponding to the recorded data X and the sound data Y to the playback device 60. The delivery of the content Cb by the delivery system 30 utilizes a technology such as streaming distribution, for example. More specifically, the delivery system 30 generates the sound of the content Cb by mixing the sound represented by the audio data X2 of the recorded data X and the sound represented by the sound data Y, and generates the content Cb that includes the video data X1 of the recorded data X and the sound data of such mixed sound. Any method can be used by the delivery system 30 to deliver the content Cb to the playback device 60. For example, besides Internet broadcasting using the communication network 200, television broadcasting, such as terrestrial or satellite broadcasting, can be used to deliver the content Cb.

The delivery system 30 includes an electronic controller, a storage device, and a communication device (not shown). The electronic controller of the delivery system 30 includes one or more processors that control each operation of the delivery system 30. The terms “electronic controller” and “processor” as used herein refer to hardware that executes a software program, and do not include a human being. For example, the electronic controller of the delivery system 30 can include one or more processors such as a CPU (Central Processing Unit), a SPU (Sound Processing Unit), a DSP (Digital Signal Processor), an FPGA (Field Programmable Gate Array), or an ASIC (Application Specific Integrated Circuit), or one or more other processors.

The storage device (computer-readable storage device) of the delivery system 30 is one or more memories (i.e., computer memories) that store programs executed by the electronic controller of the delivery system 30 and various data used by the electronic controller of the delivery system 30. The storage device of the delivery system 30 includes a known recording medium, such as a magnetic recording medium or a semiconductor recording medium. Note that the storage device of the delivery system 30 can be made up of a combination of multiple types of recording media. Further, a portable recording medium that can be attached to or detached from the delivery system 30, or a recording medium that the delivery system 30 can write to and read from via the communication network 200 (for example, cloud storage), can be used as the storage device of the delivery system 30.

The communication device of the delivery system 30 communicates with each of the recording systems 10, 20 and the playback device 60 via the communication network 200 under the control of the electronic controller of the delivery system 30. The communication device of the delivery system 30 is a hardware device capable of transmitting/receiving an analog or digital signal over the telephone, or other wired or wireless communication. The term “communication device” as used herein includes a receiver, a transmitter, a transceiver and a transmitter-receiver, capable of transmitting and/or receiving communication signals. More specifically, the communication device of the delivery system 30 receives the sound data Y transmitted from the recording system 20, and the recorded data X from the recording system 10. The communication device of the delivery system 30 also delivers the content Cb to the playback device 60.

The delivery system 30 delivers the content Cb in parallel with the progression of the competitive event (for example, live streaming). The playback device 60 plays the content Cb received from the delivery system 30 in parallel with the progression of the competition event. The user Ub views the content Cb played by the playback device 60, thereby ascertaining the status of the competitive event. More specifically, the user Ub views the video and audio represented by the recorded data X, but also listens to the audio commentary represented by the sound data Y.

The control system 40 delivers the content Ca pertaining to the competitive event to the terminal device 50. For example, a technology such as streaming distribution is used by the control system 40 to distribute the content Ca. The content Ca corresponds to the sound data Y. The control system 40 of the first embodiment delivers the sound data Y to the terminal device 50 as the content Ca. The control system 40 delivers the content Ca to the terminal device 50 in parallel with the progression of the competitive event. The terminal device 50 plays back the content Ca received from the control system 40 in parallel with the progression of the competitive event. More specifically, the audio commentary represented by the content Ca is output from the sound emitting device 53. The user Ua can therefore listen to the audio commentary of the commentator Uc as he or she views the competitive event in the venue 300. As can be understood from the foregoing description, in the first embodiment, the sound data Y is used in the generation of the content Ca and content Cb. Therefore, the processing load for generating the content C is reduced compared to a configuration in which the content Ca and the content Cb are generated separately.

It should be noted that the delivery delay between the delivery of the content Ca by the control system 40 and the delivery of the content Cb by the delivery system 30 differs. The delivery delay is the delay in the playback (reproduction) of the content C (Ca, Cb) relative to the progression of the competitive event. The length of time from the time that the commentator Uc begins his or her audio commentary of a competitive event to the time that the terminal device 50 or the playback device 60 begins playback of the audio commentary corresponds to the delivery delay.

The delivery of the content Cb by the delivery system 30 requires that the playback quality be maintained at a high level. Therefore, priority is given to avoiding such problems as delivery interruptions or reduced delivery speeds by securing sufficient buffering for temporarily storing the content Cb. In regard to the delivery of the content Ca by the control system 40, on the other hand, priority is given to delivery speed rather than playback quality. Moreover, whereas the content Cb includes video as well as audio, the content Ca includes only audio commentary. Due to these circumstances, in the first embodiment, the delivery delay of the content Ca to the terminal device 50 is shorter compared to that of the content Cb to the playback device 60.

As described above, the delivery of the content Cb by the delivery system 30 is accompanied by a relatively large delivery delay. Therefore, if the content Cb is delivered to the terminal device 50 in the venue 300, the content Cb is played back with a delay relative to the progression of the competitive event that the user Ua is actually watching. In contrast to this case, in the first embodiment, the content Ca is delivered to the terminal device 50 with a shorter delivery delay than the delivery delay of the content Cb. Therefore, the terminal device 50 can play the content Ca in an environment in which the delivery delay is shorter than when the terminal device 50 in the venue 300 plays the content Cb. In other words, the user Ua in the venue 300 can listen to the audio commentary without a significant delay in the progression of the competitive event. The delay of the audio commentary in the content Cb is not a particular problem for the user Ub, because the sound data Y is delayed as much as the recorded data X in the content Cb.

FIG. 3 is a block diagram showing the configuration of the control system 40. The control system 40 includes a control device 41, a storage device 42, and a communication device 43. Note that the control system 40 can be realized not only as a single device, but also as a plurality of devices configured separately from each other.

The control device (electronic controller) 41 includes one or more processors that control each element of the control system 40. The terms “electronic controller” and “processor” as used herein refer to hardware that executes a software program, and do not include a human being. For example, the control device 41 can include one or more processors such as a CPU (Central Processing Unit), a SPU (Sound Processing Unit), a DSP (Digital Signal Processor), an FPGA (Field Programmable Gate Array), or an ASIC (Application Specific Integrated Circuit), or one or more other processors.

The storage device (computer-readable storage device) 42 is one or more memories (i.e., computer memories) that store programs executed by the control device 41 and various data used by the control device 41. The storage device 42 includes a known recording medium, such as a magnetic recording medium or a semiconductor recording medium. Note that the storage device 42 can be made up of a combination of multiple types of recording media. Further, a portable recording medium that can be attached to or detached from the control system 40, or a recording medium that the control system 40 can write to and read from via the communication network 200 (for example, cloud storage), can be used as the storage device 42.

The communication device 43 communicates with each of the recording system 20 and the terminal device 50 via the communication network 200 under the control of the control device 41. The communication device 43 is a hardware device capable of transmitting/receiving an analog or digital signal over the telephone, or other wired or wireless communication. The term “communication device” as used herein includes a receiver, a transmitter, a transceiver and a transmitter-receiver, capable of transmitting and/or receiving communication signals. More specifically, the communication device 43 receives the sound data Y transmitted from the recording system 20. The communication device 43 also delivers the content Ca corresponding to the sound data Y to the terminal device 50.

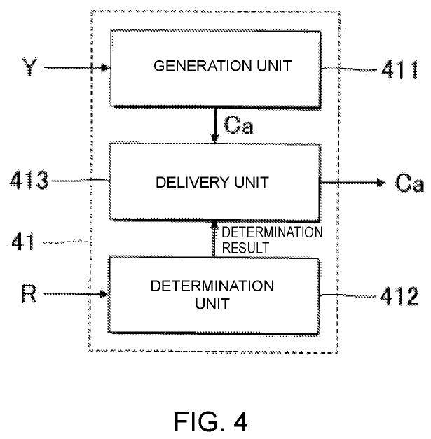

FIG. 4 is a block diagram showing the functional configuration of the control system 40. As shown in FIG. 4, by executing the programs stored in the storage device 42, the control device 41 realizes a plurality of functions (generation unit 411, determination unit 412, and delivery unit 413) in order to deliver the content Ca corresponding to the sound data Y to the terminal device 50.

The generation unit 411 generates the content Ca corresponding to the sound data Y. The generation unit 411 of the first embodiment receives the sound data Y transmitted from the recording system 20 via the communication device 43 and stores the sound data Y in the storage device 42 as the content Ca.

The determination unit 412 determines whether the terminal device 50 is located at the venue 300 in which the competitive event is held. As shown in FIG. 4, the determination unit 412 receives a delivery request R that is transmitted from the terminal device 50 via the communication device 43. The delivery request R is transmitted from the terminal device 50 to the control system 40 in response to an instruction from the user Ua. The delivery request R includes location information that indicates the location of the terminal device 50 and identification information for identifying the terminal device 50. The terminal device 50 generates location information by, for example, a GPS (Global Positioning System) or an IP (Internet Protocol) address. The storage device 42 also stores a prescribed range (referred to as the “reference range” below) that includes the venue 300 on a map. The determination unit 412 determines whether the terminal device 50 is located at the venue 300 depending on whether the location of the terminal device 50 indicated by the location information is within the reference range. As can be understood from the foregoing description, the determination unit 412 determines whether the terminal device 50 is located at the venue 300 in accordance with the information transmitted from the terminal device 50 (specifically, the delivery request R).

The delivery unit 413 delivers the content Ca to the terminal device 50 via the communication device 43. As described above, the delivery of the content Ca is executed in parallel with the progression of the competitive event. As explained above, the content Ca corresponding to the sound data Y, which is recorded in parallel with the progression of the competitive event, is delivered to the terminal device 50. In this way, the content Ca, which appropriately reflects the progression of the competitive event, can be delivered to the terminal device 50.

The delivery unit 413 of the first embodiment delivers the content Ca to the terminal device 50 when the determination result from the determination unit 412 is positive (i.e., when the delivery unit 413 determines that the terminal device 50 is located at the venue 300). That is, the delivery unit 413 only delivers the content Ca to the terminal device 50 that is located inside the venue 300 and does not deliver the content Ca to the terminal device 50 that is located outside the venue 300. In the above-mentioned manner, the content Ca is delivered only to one or more terminal devices 50 which are located within the venue 300, from among the plurality of terminal devices 50 that have sent the delivery request R to the control system 40.

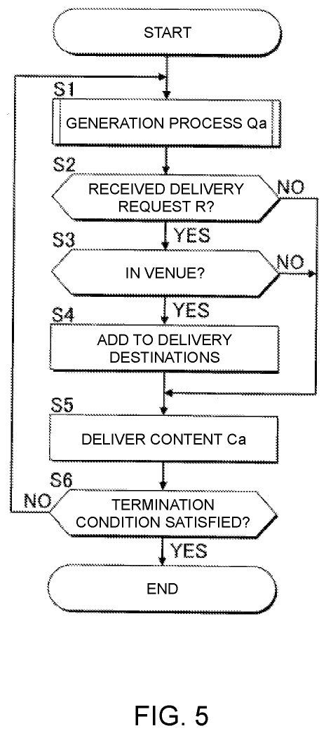

FIG. 5 shows a flowchart of the detailed procedure of the process executed by the control system 41 (referred to as the “control processing” below). The control process is initiated by an instruction from the operator of the competitive event and continues in parallel with the progression of the competitive event. Note that the recording system 20 sequentially transmits the sound data Y to the control system 40 in parallel with the control processing.

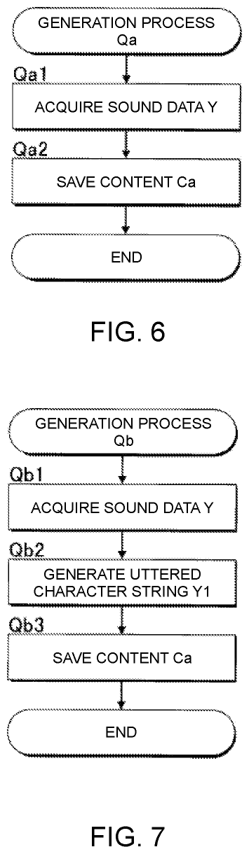

Once the control process is initiated, the generation unit 411 executes a process for generating the content Ca (referred to as the “generation process” below) (S1). FIG. 6 shows a flowchart of the procedure of the generation process Qa of the first embodiment.

When the generation process Qa is initiated, the generation unit 411 acquires the sound data Y (Qa1). More specifically, the generation unit 411 receives the sound data Y transmitted from the recording system 20 via the communication device 43. The generation unit 411 then generates the content Ca corresponding to the sound data Y (Qa2). More specifically, the generation unit 411 stores the sound data Y as the content Ca in the storage device 42.

After the generation process Qa is executed, as indicated in FIG. 5, the determination unit 412 determines whether the communication device 43 has received the delivery request R transmitted from the terminal device 50 (S2). If the delivery request R is received (S2: YES), the determination unit 412 determines whether the terminal device 50 from which the delivery request R was transmitted is located in the venue 300 (S3). More specifically, if the location indicated by the location information in delivery request R is within the reference range, the determination unit 412 determines that the terminal device 50 is located within the venue 300. If, on the other hand, the location indicated by the location information is outside the reference range, the determination unit 412 determines that the terminal device 50 is not located within the venue 300.

If the determination unit 412 determines that the terminal device 50 is located within the venue 300 (S3: YES), the delivery unit 413 registers the terminal device 50 that was the source of the delivery request R as a content Ca delivery destination (S4). For example, the delivery unit 413 stores the identification information that is included in the delivery request R in the storage device 42 as information for identifying a content Ca delivery destination. If, on the other hand, the determination unit 412 determines that the terminal device 50 is not located within the venue 300 (S3: NO), the terminal device 50 that was the source of the delivery request R is not registered as a content Ca delivery destination. For example, the identification information of the terminal device 50 is not stored in the storage device 42. If the delivery request R is not received (S2: NO), the determination (S3) and addition to the delivery destinations (S4) by the determination unit 412 are not performed.

The delivery unit 413 delivers the content Ca from the communication device 43 to each of the terminal devices 50 registered as delivery destinations (S5). As can be understood from the foregoing explanation, the content Ca is delivered to the terminal devices 50 for which the determination result by the determination unit 412 is positive (S3: YES), and the content Ca is not delivered to the terminal devices 50 for which the determination result is negative (S3: NO). That is, the content Ca is delivered to one or more terminal devices 50 that are within the venue 300, and the content Ca is not delivered to one or more terminal devices 50 that are outside the venue 300.

The control device 41 determines whether a prescribed termination condition has been satisfied (S6). For example, when the operator of a competitive event issues an instruction to terminate the control process, the control device 41 determines that the termination condition has been satisfied. Note, for example, that the termination condition can be the arrival of the time when the event ends. If the termination condition is not satisfied (S6: NO), the control device 41 returns to Step S1. That is, the limited distribution of the content Ca to the terminal devices 50 located in the venue 300 is repeated. When the termination condition is satisfied (S6: YES), the control device 41 terminates the control process. Note that it is also possible for the control device 41 to terminate control processing if, as the termination condition, the terminal device 50 receives a termination instruction from the user Ua.

As explained above, in the first embodiment, the distribution of the content Ca pertaining to the competitive event is limited to the terminal devices 50 that are located at the venue 300 of the competitive event. The users Ua in the venue 300 can view and/or listen to the content Ca while watching the progression of the competitive event. A large number of the users Ua can thereby be encouraged to visit the venue 300.

### B: Second Embodiment

A second embodiment will now be described. In each aspect described below, for those elements whose functions correspond to similar elements of the first embodiment, the same reference numerals that were used in the description of the first embodiment will be used here, and their detailed descriptions will be omitted as deemed appropriate.

In the first embodiment, an example was used in which the sound data Y representing audio commentary is delivered to the terminal device 50 as the content Ca. In the second embodiment, a character string corresponding to the audio commentary (referred to as an “uttered character string” below) Y1 is delivered to the terminal device 50 as the content Ca.

FIG. 7 shows a flowchart of the procedure of the generation process Qb in which the control device 41 generates the content Ca in the second embodiment. In the second embodiment, the generation process Qa of FIG. 6 has been replaced in FIG. 7 with the generation process Qb.

When the generation process Qb is initiated, as in the first embodiment, the generation unit 411 acquires the sound data Y (Qb1). The generation unit 411 generates an uttered character string Y1 by subjecting the sound data Y to a speech recognition process (Qb2). The uttered character string Y1 is a character string that represents the speech content of the audio commentary. Any known speech recognition method that uses an acoustic model, such as HMM (Hidden Markov Model), and a language model that imposes linguistic constraints can be arbitrarily employed for the speech recognition of the sound data Y. The generation unit 411 stores the uttered character string Y1 as the content Ca in the storage device 42 (Qb3).

As explained above, the content Ca of the second embodiment is the uttered character string Y1 identified by speech recognition of the sound data Y. Note that the operation (S2 to S6) of distributing the content Ca to the terminal devices 50 based on the condition that the terminal devices 50 be located within the venue 300 is the same as in the first embodiment. The display device 52 of the terminal device 50 displays the uttered character string Y1 of the content Ca received from the control system 40. That is, while viewing the competitive event in the venue 300, the user Ua can visually recognize the uttered character string Y1 corresponding to the audio commentary of the commentator Uc.

The second embodiment realizes the same effect as that of the first embodiment. In the second embodiment, since the uttered character string Y1 corresponding to the audio commentary is displayed on the terminal device 50, a user who has difficulty hearing the audio commentary (e.g., a hearing-impaired person), for example, can check the content of the audio commentary in regard to the competitive event.

In the foregoing description, the control device 41 (generation unit 411) of the control system 40 subjects the sound data Y to a speech recognition process, but a speech recognition system separate from the control system 40 can also be used for speech recognition processing of the sound data Y. The generation unit 411 transmits the sound data Y from the communication device 43 to the speech recognition system and receives the uttered character string Y1, which has been generated by the speech recognition system by speech recognition on the sound data Y, from the speech recognition system via the communication device 43.

### C: Third Embodiment

In the second embodiment, the uttered character string Y1 that represents the audio commentary is delivered to the terminal device 50 as the content Ca. The uttered character string Y1 is expressed in the same language as the audio commentary (referred to as “first language” below). In a third embodiment, a string Y2 obtained by translating the uttered character string Y1 from the first language to the second language (referred to as the “translated character string” below) is delivered to the terminal device 50 as the content Ca. The second language is a different language than the first language.

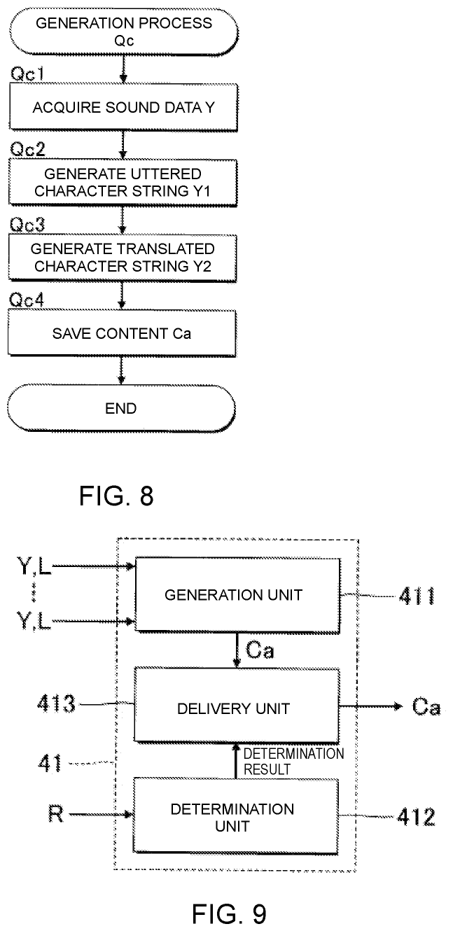

FIG. 8 shows a flowchart of the procedure of the generation process Qc in which the control device 41 generates the content Ca in the third embodiment. In the third embodiment, the generation process Qa of FIG. 6 has been replaced in FIG. 8 with the generation process Qc.

When the generation process Qc is initiated, as in the first embodiment, the generation unit 411 acquires the sound data Y (Qc1). The generation unit 411 generates the uttered character string Y1 by subjecting the sound data Y to a speech recognition process, as in the second embodiment (Qc2). The generation unit 411 also generates a translated character string Y2 in a second language by a machine translation of the uttered character string Y1 in the first language (Qc3). The second language is selected for each terminal device 50 in accordance with an instruction from the user Ua on the terminal device 50.

Any known technology can be adopted for machine translation of the uttered character string Y1. For example, rule-based machine translation, which converts the word order and words by referring to the results of parsing the uttered character string Y1 and to linguistic rules, or statistical machine translation, which converts the uttered character string Y1 into the translated character string Y2 by using a statistical model that represents statistical trends in the language, are used to generate the translated character string Y2. The generation unit 411 stores the translated character string Y2 as the content Ca in the storage device 42 (Qc4).

As explained above, the content Ca of the third embodiment is the translated character string Y2 generated by speech recognition and machine translation processing of the sound data Y. Note that the operation (S2 to S6) of delivering the content Ca to the terminal device 50 based on the condition that the terminal device 50 be located in the venue 300 is the same as in the first embodiment. The display device 52 of the terminal device 50 displays the translated character string Y2 of the content Ca that is received from the control system 40. That is, while viewing the competitive event in the venue 300, the user Ua can visually recognize the translated character string Y2, which is a second language representation of the audio commentary.

The third embodiment realizes the same effect as that of the first embodiment. In the third embodiment, since the translated character string Y2 in the second language corresponding to the audio commentary is displayed on the terminal device 50, a user who has difficulty understanding the first language (e.g., a person from abroad), for example, can check the content of the audio commentary in regard to the competitive event.

In the foregoing description, the control device 41 (generation unit 411) of the control system 40 subjects the uttered character string Y1 to machine translation, but a machine translation system separate from the control system 40 can also be used for machine-translating the uttered character string Y1. The generation unit 411 transmits the uttered character string Y1 from the communication device 43 to the machine translation system and receives the translated character string Y2, which has been generated by the machine translation system by machine-translating the uttered character string Y1, from the machine translation system via the communication device 43. A speech recognition system separate from the control system 40 can also be used to perform speech recognition of the sound data Y.

### D: Fourth Embodiment

In the first embodiment, the content Ca that corresponds to the sound data Y transmitted by the recording system 20 was distributed to the terminal devices 50. In a fourth embodiment, the content Ca that corresponds to any of a plurality of pieces of the sound data Y recorded at different locations in the venue 300 is selectively distributed to the terminal devices 50.

FIG. 9 is a block diagram showing the functional configuration of the control system 40 of the fourth embodiment. The generation unit 411 of the fourth embodiment obtains a plurality of pieces of the sound data Y recorded at different locations in the venue 300 (Qa1). The plurality of pieces of the sound data Y includes, for example, the sound data Y generated by the recording system 20 as well as the sound data Y generated by each terminal device 50 in the venue 300. More specifically, the sound data Y generated by the recording system 20 are transmitted to the control system 40 as in the first embodiment, and the sound data Y generated by each terminal device 50 by sound recording using a sound recording device (sound recorder, not shown) are transmitted to the control system 40 (generation unit 411) for each terminal device 50. The sound data Y transmitted by the terminal device 50 are, for example, data that represent sound such as speech uttered by the user Ua who uses the terminal device 50. Each piece of the plurality of sound data Y is transmitted to the control system 40 together with information indicating the location L where the sound of the sound data Y was recorded (referred to as “recording location” below). Location information that indicates the location of the terminal device 50, for example, is used as information that indicates the recording location L.

Further, the generation unit 411 generates a plurality of pieces of the content Ca that correspond to different pieces of sound data Y (Qa2). The content Ca that corresponds to each piece of the sound data Y is stored in the storage device 42 in association with the recording location L of the sound data Y.

The delivery unit 413 of the fourth embodiment selectively transmits any of the plurality of pieces of the content Ca stored in the storage device 42 to the terminal device 50. For example, in the fourth embodiment, the delivery request R transmitted from the terminal device 50 includes location and identification information of the terminal device 50, as well as a desired location in the venue 300 (referred to as “target location” below). The target location is, for example, a location specified by the user Ua of the terminal device 50. The delivery unit 413 delivers to the requesting terminal device 50 the content Ca, of the plurality of pieces of the content Ca stored in the storage device 42, which corresponds to the recording location L that is close to the target location (for example, the recording location L closest to the target location) (S5). As can be understood from the foregoing description, the delivery unit 413 of the fourth embodiment delivers to the terminal device 50 the content Ca that corresponds to any of the plurality of pieces of the sound data Y recorded at different locations of the venue 300. Note that the basic operation of the control system 40, such as the operation of distributing the content Ca to the terminal devices 50 based on the condition that the terminal devices 50 be located in the venue 300, is the same as in the first embodiment.

The fourth embodiment realizes the same effect as that of the first embodiment. Also, in the fourth embodiment, since the content Ca that corresponds to any of a plurality of types of the sound data Y is distributed to the terminal devices 50, a variety of the content Ca can be delivered to the terminal devices 50 compared to a configuration in which the content Ca corresponding to only one type of sound data Y is delivered to the terminal devices 50.

Although in the foregoing description a configuration is assumed in which each of the plurality of pieces of sound data Y is distributed to the terminal devices 50 as the content Ca, the relationship between the sound data Y and the content Ca is not limited to the above-described example. For example, the configurations of the second embodiment, in which the uttered character string Y1 generated from sound data Y is employed as the content Ca, and of the third embodiment, in which the translated character string Y2 generated from the sound data Y is employed as the content Ca, can likewise be applied to the fourth embodiment.

### E: Variants

Examples of specific modifications added to each of the above-mentioned aspects will be discussed below. A plurality of aspects arbitrarily selected from the following examples can be combined as deemed appropriate insofar as they are not mutually contradictory.
(1) In each of the embodiments described above, the location information of the terminal device 50 is used to determine whether the terminal device 50 is located in the venue 300, but the method for determining whether the terminal device 50 is located in the venue 300 (referred to as “location determination” below) is not limited to the foregoing embodiments. Specific examples of location determination are illustrated below.

### First Aspect

Information that can be received on a limited basis by the terminal device 50 in the venue 300 (referred to as “venue information” below) can be used for location determination. For example, a case is assumed in which venue information is transmitted from a transmitter installed in the venue 300 to the terminal device 50 by short-range wireless communication. The range over which the venue information is transmitted is limited to the venue 300. In this case, when the control system 40 receives venue information from the terminal device 50, the determination unit 412 can determine that the terminal device 50 is located at the venue 300. Examples of short-range wireless communication include Bluetooth (registered trademark) or Wi-Fi (registered trademark) wireless communication, or acoustic communication that uses sound waves emitted from a sound emitting device (transmitter) as a transmission medium.

### Second Aspect

Venue information that can be acquired by reading image patterns can be used for location determination. An image pattern is an optically readable coded image, such as a QR code (registered trademark) or a barcode. The image pattern is displayed exclusively within the venue 300. That is, a terminal device 50 located outside the venue 300 cannot read the image pattern. In this case, when the control system 40 receives venue information obtained by the terminal device 50 by reading the image pattern from the terminal device 50, the determination unit 412 can determine that the terminal device 50 is located at the venue 300.

### Third Aspect

An electronic ticket held in the terminal device 50 for the user Ua to enter the venue 300 can be used for location determination. The electronic ticket includes admission information indicating whether the user Ua has entered the venue 300. In this case, when the admission information is received by the control system 40 from the terminal device 50, the determination unit 412 can determine that the terminal device 50 is located at the venue 300.

As can be understood from the foregoing examples, information transmitted from the terminal device 50 (referred to as “reference information” below) can be used for the location determination. In addition to the location information in each of the embodiments above, the reference information is the venue information used in the form of an example in the first aspect and the second aspect, or the electronic ticket used in the form of an example in the third aspect. The reference information can be transmitted to the control system 40 as the delivery request R along with the identification information of the terminal device 50, or transmitted to the control system 40 as separate information from the delivery request R.

In addition to the foregoing examples, various types of authentication, such as facial authentication using an image of the user Ua's face, and authentication using a pre-registered password, can also be used to determine whether the terminal device 50 is located at the venue 300.
(2) Any of a plurality of pieces of the content Ca generated by sharing the sound data Y can be selectively distributed to the terminal devices 50. For example, one or more of pieces of the content Ca among the content Ca including the sound data Y, the content Ca that represents the uttered character string Y1 corresponding to the sound data Y, and the content Ca that represents the translated character string Y2 corresponding to the sound data Y are distributed to the terminal devices 50 via the delivery unit 413. Of the plurality of pieces of content Ca, the content Ca which is to be distributed to the terminal devices 50 is selected, for example, in response to an instruction from the user Ua. The plurality (three types) of the content Ca used as examples above are comprehensively represented as information representing audio.
(3) The relationship between the sound data Y and the content Ca is not limited to the examples in the foregoing embodiments. For example, in the third embodiment, a sound/voice reading the translated character string Y2 can be generated by speech synthesis, and the generation unit 411 can generate the content Ca that represents voice. The sound emitting device 53 of the terminal device 50 plays back the content Ca. In addition, for speech synthesis that applies the translated character string Y2, for example, segment connection type speech synthesis connecting multiple speech segments, or a statistical model type of speech synthesis using a statistical model such as a deep neural network or HMM (Hidden Markov Model) can be used. The content Ca for each of the foregoing embodiments and this variant is an example of the type of content Ca that corresponds to the sound data Y.
(4) In the third embodiment, the translated character string Y2 is generated by subjecting the sound data Y to speech recognition and machine translation processing, but the method of generating the translated character string Y2 is not limited to the foregoing example. For example, the translated character string Y2 can be generated by an editor who manually edits a character string generated by machine translation of the uttered character string Y1. Alternatively, a translator who listens to the sound data Y can manually input the translated character string Y2. A translator who listens to the audio of the sound data Y can vocalize the translated text, and the sound data in which the voice is stored can be distributed to the terminal devices 50 as the content Ca. Alternatively, the translated character string Y2 can be generated by subjecting the sound data Y of the speech uttered by the translator to speech recognition processing.

Although the foregoing focused on the translated character string Y2, a similar mode is conceivable for the uttered character string Y1. For example, the uttered character string Y1 can be generated by an editor who manually edits a character string generated by speech recognition of the sound data Y. Alternatively, a worker who listens to the sound data Y can also manually input the uttered character string Y1. The content Ca generated by manual operation by a translator or a worker as described above can also be included in the concept of the “first content” of this disclosure.
(5) Although in each of the foregoing embodiments, the sound data Y recorded by the recording system 20 is used to generate the content Ca and content Cb, the sound data Y need not be used to generate the content Cb used by the delivery system 30. That is, the sound data Y generated by the recording system 20 need not be transmitted to the delivery system 30.
(6) Although in each of the foregoing embodiments, the content Ca is generated from the sound data Y, the data used to generate the content Ca is not limited to the sound data Y that represent audio commentary. For example, video data representing images taken inside the venue 300 by an imaging device can be used to generate the content Ca. For example, video data are distributed to the terminal devices 50 as the content Ca. The content Ca can also be generated that includes both the sound data Y and video data. The data used to generate the content Ca are comprehensively represented as recorded data that are recorded in parallel with the progression of the competitive event. Typical examples of recorded data are the sound data Y and video data.
(7) As described above, the functions of the control system 40 that serve as examples are realized by the cooperation of one or a plurality of processors that make up the control device 41 and programs stored in the storage device 42. The programs described above that serve as examples can be provided in a form stored on a computer-readable storage medium and installed on a computer. The storage medium is, for example, a non-transitory storage medium, a good example of which is an optical recording medium such as a CD-ROM, but any known format of storage medium such as a semiconductor recording medium or magnetic recording medium is also included. Note that the non-transitory storage medium includes any storage medium which exclude transitory, propagating signals, and volatile storage media are also included. In a configuration in which a delivery device delivers a program via a communication network, a storage medium for storing programs in the delivery device corresponds to the above-mentioned non-transitory storage medium.

### F: Appendix

From the foregoing exemplified embodiments, the following configurations can be understood, for example.

A control system operation method according to one aspect of this disclosure (Aspect 1) comprises determining whether a terminal device is located at a venue where an event is taking place, and delivering a first content pertaining to the event to the terminal device in parallel with the progression of the event when the result of the determination is positive. In this aspect, the first content pertaining to the event is delivered only to terminal devices located at the venue of the event. Users located at the venue can view and/or listen to the first content related to the event while watching the progression of the event within the venue. In this way, users can be encouraged to visit the venue.

An “event” refers to various types of entertainment that can be viewed by users. The concept of “event” includes various events held for specific purposes, such as a competitive event in which plural competitors (teams) compete in a given sport, a performance event (e.g., a concert or live performance) in which performers such as singers or dancers perform, an exhibition event in which various goods are exhibited, an educational event in which various educational institutions such as schools or tutorial academies provide classes to students, or a lecture event in which speakers such as experts or knowledgeable persons give lectures on various topics. A typical example of an event is an entertainment event.

The “venue” is any facility where an event takes place. More specifically, the concept of “venue” includes various locations, whether indoors or outdoors, such as stadiums where competitive events are held, concert halls or outdoor live venues where performance events (e.g., concerts or live performances) are held, exhibition halls where exhibitions are held, educational facilities where educational events are held, or lecture facilities where lecture events are held.

The “first content” is information (digital content) provided to a user's terminal device, and includes, for example, video and/or audio. A typical example of first content is audio of event commentary.

The operation method according to the specific example of Aspect 1 (Aspect 2) further includes the acquisition of recorded data recorded in parallel with the progression of the event, and in the delivery of first content, the first content corresponding to the recorded data is delivered to a terminal device. According to this aspect, the first content corresponding to the recorded data recorded in parallel with the progression of the event is distributed to the terminal devices. Therefore, the first content, which appropriately reflects the progression of the event, can be delivered to the terminal devices.

The “recorded data” are, for example, data representing video or audio recorded in parallel with the progression of the event. The “first content corresponding to the recorded data” is, for example, content that is generated using recorded data. More specifically, it is assumed that the first content is generated by various types of processing of the recorded data, or that the recorded data are used as the first content.

In a specific example of Aspect 2 (Aspect 3), the recorded data are transmitted in parallel with the progression of the event to a delivery system that delivers a second content corresponding to the recorded data to a playback device. In this aspect, the recorded data corresponding to the first content is also used for the second content that is delivered to the playback device by the delivery system. Therefore, the processing load for generating the second content is reduced.

The “second content” is the information (digital content) provided to the playback device and includes, for example, video and/or audio. A typical example of the second content is video content of the recording of the state of an event. The “second content corresponding to the recorded data” is, for example, content generated using recorded data. More specifically, it is assumed that the second content is generated by various types of processing of the recorded data, or that the recorded data are used as the second content. For example, in a case in which the sound data representing the audio of event commentary are used as the recorded data, the “second content” is content that is a combination of video data which is the recorded video of an event and the sound data.

The “playback device” is any device that can play back the second content. For example, in addition to information devices such as smartphones, tablet terminals, and personal computers, video devices such as television receivers, are also included in the concept of “playback device”.

In a specific example of Aspect 3 (Aspect 4), a delivery delay of the first content to the terminal device is smaller than the delivery delay of the second content to the playback device. If the terminal device in a venue plays the second content, a delay in the delivery of the second content with respect to the event becomes a problem. In the above aspect, the first content is delivered to the terminal device with a delivery delay that is smaller than that of the second content. Therefore, the terminal device can play the first content in an environment in which the delivery delay is smaller than when the terminal device in the venue plays the second content. That is, users at the venue can view the first content without excessive delays in the progression of the event being viewed.

The “delivery delay” refers to a delay in the playback of the content with respect to the event. That is, the length of time between the occurrence of a specific event in an event and the time of actual playback of the event in the content is a specific example of the “delivery delay.”

In any of the specific examples from Aspect 2 to Aspect 4 (Aspect 5), the recorded data include sound data (audio data) which are sound (audio) of an event. According to this aspect, the first content corresponding to the sound (audio) related to the event can be delivered to the terminal device at the venue.

The “sound (audio) related to the event” is, for example, voice that provides event commentary. The sound data of speech uttered by users in the venue in parallel with the progression of the event are also used as the “recorded data.”

In the specific example of Aspect 5 (Aspect 6), a character string is generated by sound recognition of the sound data, and the first content represents the character string. According to this aspect, since a character string corresponding to speech pertaining to an event is displayed on a terminal device, a user who has difficulty hearing (for example, a hearing-impaired person) can confirm the content of the speech pertaining to the event.

In a specific example of Aspect 5 (Aspect 7), a first character string in a first language is generated by speech recognition of the sound data, a second character string in a second language different from the first language is generated by machine translation of the first character string, and the first content represents the second character string. According to this aspect, since the character string in the second language translated from speech pertaining to an event is displayed on the terminal device, a user (for example, a person from abroad) who has difficulty understanding the first language can check the content of the speech pertaining to the event.

The operation method according to a specific example of Aspect 1 (Aspect 8) further includes the acquisition of a plurality of recorded data recorded at different locations of the venue in parallel with the progression of the event, and in the delivery of first content, the first content corresponding to any of the plurality of recorded data is delivered to the terminal device. In this aspect, since the first content corresponding to any of the plurality of recorded data is delivered to the terminal device, a variety of first content can be delivered to the terminal device compared to a configuration in which the first content corresponding to only one type of recorded data is delivered to the terminal device.

The source of the “plurality of recorded data” is arbitrary. For example, recorded data generated by a recording system installed at a venue can be used. The recording data recorded by the recording system includes, for example, sound data representing event commentary (e.g., audio that provides live commentary pertaining to an event). In addition, recorded data recorded by terminal devices at the venue can be used. The recorded data recorded by terminal devices includes, for example, sound data representing speech uttered by users viewing an event at the venue.

In any of the specific examples (Aspect 9) from Aspect 1 to Aspect 8, the determination of whether the terminal device is located at the venue is determined according to the reference information transmitted from the terminal device. According to this aspect, whether the terminal device is located at the venue can be accurately determined by using the reference information transmitted from the terminal device.

In the specific example of Aspect 9 (Aspect 10), the reference information is the location information of the terminal device. According to this aspect, whether the terminal device is located at the venue can be accurately determined by using the location information of the terminal device. Note that it is also possible to generate the location information by receiving GPS (Global Positioning System) signals or other satellite signals, or by using wireless base stations which are used in mobile telecommunications, Wi-Fi (registered trademark), or other types of wireless communication.

In the specific example of Aspect 9 (Aspect 11), the reference information is the venue information that can be received on a limited basis by a terminal device in the venue. According to this aspect, whether a terminal device is located at the venue can be easily determined by using venue information that can be received on a limited basis by the terminal device in the venue.

In the specific example of Aspect 9 (Aspect 12), the reference information is an electronic ticket held in the terminal device for a user of the terminal device to enter the venue. According to this aspect, the electronic ticket for the user of the terminal device to enter the venue can also be used to determine whether the terminal device is located at the venue.

The control system, according to one aspect of this disclosure (Aspect 13), comprises a determination unit that determines whether a terminal device is located at the venue where an event is taking place and a delivery unit that delivers to the terminal device first content pertaining to the event in parallel with the progression of the event when the determination result is positive.

The program according to one aspect (Aspect 14) of this disclosure includes a determination unit for determining whether a terminal device is located at the venue where an event is taking place, and when the determination result is positive, a delivery unit for delivering first content pertaining to the event to the terminal device in parallel with the progression of the event, wherein the program causes the computer system to function as a delivery unit that delivers the first content pertaining to the event to the terminal device in parallel with the progression of the event.

What is claimed is:

1. A control system operation method comprising:
determining whether a terminal device is located at a venue where an event is taking place; and
delivering first content pertaining to the event to the terminal device in parallel with progression of the event, in response to determining that the terminal device is located at the venue.

2. The control system operation method according to claim 1, further comprising
acquiring recorded data recorded in parallel with the progression of the event, wherein
in the delivering of the first content, the first content corresponding to the recorded data is delivered to the terminal device.

3. The control system operation method according to claim 2, wherein
the recorded data are transmitted in parallel with the progression of the event to a delivery system configured to deliver second content corresponding to the recorded data to a playback device.

4. The control system operation method according to claim 3, wherein
a delay in the delivering of the first content to the terminal device is smaller than a delay in delivering of the second content to the playback device.

5. The control system operation method according to claim 2, wherein
the recorded data include sound data that represent sound related to the event.

6. The control system operation method according to claim 5, further comprising
generating a character string by speech recognition of the sound data, the first content representing the character string.

7. The control system operation method according to claim 5, further comprising
generating a first character string in a first language by speech recognition of the sound data, and
generating a second character string in a second language different than the first language by machine translation of the first character string, the first content representing the second character string.

8. The control system operation method according to claim 1, further comprising
acquiring a plurality of pieces of recorded data recorded at different locations of the venue in parallel with the progression of the event, wherein
the delivering of the first content is performed by delivering the first content corresponding to any of the plurality of pieces of recorded data to the terminal device.

9. The control system operation method according to claim 1, wherein
the determining is performed by determining whether the terminal device is located at the venue based on reference information transmitted from the terminal device.

10. The control system operation method according to claim 9, wherein
the reference information is location information of the terminal device.

11. The control system operation method according to claim 9, wherein
the reference information is venue information that is receivable on a limited basis by the terminal device in the venue.

12. The control system operation method according to claim 9, wherein
the reference information is an electronic ticket held in the terminal device for a user of the terminal device to enter the venue.

13. A control system comprising:
an electronic controller including at least one processor configured to
determine whether a terminal device is located at a venue where an event is taking place, and
deliver first content pertaining to the event to the terminal device in parallel with progression of the event, in response to determination that the terminal device is located at the venue.

14. A non-transitory computer-readable medium storing a program that causes a computer system to perform functions comprising:
determining whether a terminal device is located at a venue where an event is taking place, and
delivering first content pertaining to the event to the terminal device in parallel with the progression of the event, in response to determining that the terminal device is located at the venue.
